(19) United States
(12) Patent Application Publication
(10) Pub. No.: US 2022/0083956 A1
(43) Pub. Date: Mar. 17, 2022

(54) STOCK MANAGEMENT SYSTEM

(71) Applicant: TOSHIBA TEC KABUSHIKI KAISHA, Tokyo (JP)

(72) Inventor: Yasuhiro NAKAJIMA, Shizuoka (JP)

(73) Assignee: TOSHIBA TEC KABUSHIKI KAISHA, Tokyo (JP)

(21) Appl. No.: 17/331,042

(22) Filed: May 26, 2021

(30) Foreign Application Priority Data
Sep. 17, 2020 (JP) 2020-156682

(51) Int. Cl. G06Q 10/08; G06K 7/10

(52) U.S. Cl. CPC G06Q 10/087; G06K 7/10316; G06K 7/10108; G06K 7/10039

(57) ABSTRACT

A stock management system includes a theoretical-stock acquiring unit configured to acquire information concerning theoretical stocks of commodities individually managed by wireless tags, a reading processing unit configured to read information received by an antenna, a comparison processing unit configured to compare the information acquired by the theoretical-stock acquiring unit and the information read by the reading processing unit to associate theoretical stock numbers and measured stock numbers of the commodities, a details presenting unit configured to show, among serial numbers of commodities, the measured stock numbers of which exceed the theoretical stock numbers thereof, at least serial numbers not included in the theoretical stocks, and a search processing unit configured to search for a wireless tag matching the serial number selected from the serial numbers shown by the details presenting unit.

### CROSS-REFERENCE TO RELATED APPLICATION

This application is based upon and claims the benefit of priority from Japanese Patent Application No. 2020-156682, filed on Sep. 17, 2020, the entire contents of which are incorporated herein by reference.

### FIELD

Embodiments described herein relate generally to stock management system.

### BACKGROUND

A system is known that performs stock management of articles using wireless tags attached to the articles in a store or the like (for example, JP-A-2010-70332 (Patent Literature 1) and JP-A-2010-44724 (Patent Literature 2)). The wireless tag is, for example, an RF tag. The RF tag is an IC tag adapted to RFID (Radio Frequency Identification, that is, a technique for exchanging information by short-range wireless communication using a radio wave).

In such a system, an inventory job is performed by acquiring, with a reading device incorporating an antenna, information (an individual article code and an EPC (Electronic Product Code) stored by the wireless tag in a noncontact manner from a position away from the wireless tag by, for example, approximately 30 cm to 10 m.

In the inventory job, for example, the number of theoretical stocks (a theoretical number) obtained from management information of articles and the number of wireless tags actually read by the reading device (a measured number) are compared. As a result of the comparison, the measured number sometimes exceeds the theoretical number. In this case, sold commodities (or wireless tags attached to the sold commodities) and commodities before being warehoused are considered to be mixed in commodities of the theoretical stocks.

If commodities (or wireless tags) not included in the theoretical stocks are mixed in the commodities of the theoretical stocks, accuracy of the stock management is spoiled. Accordingly, it is desirable to find excess wireless tags not included in the theoretical stocks and then determine whether to treat the excess wireless tags as measured stocks. However, known stock management systems are not configured to support the finding of the excess wireless tags and the subsequent determination (whether to treat the excess wireless tags as the measured stocks).

### DESCRIPTION OF THE DRAWINGS

FIG. 1 is a diagram schematically illustrating the configuration of a stock management system in at least one embodiment;

FIG. 2 is a diagram schematically illustrating a state during use of the stock management system;

FIG. 3 is a block diagram illustrating a schematic configuration of a server;

FIG. 4 is a block diagram illustrating a schematic configuration of a reading device;

FIG. 5 is a block diagram illustrating a functional configuration of a control unit;

FIG. 6A is a flowchart schematically illustrating a flow of processing performed by control units of the reading device and the server;

FIG. 6B is a flowchart schematically illustrating the flow of the processing performed by the control units of the reading device and the server;

FIG. 7 is a diagram illustrating an example of a menu screen displayed by the reading device;

FIG. 8 is a diagram illustrating an example of an inventory target selection screen displayed by the reading device;

FIG. 9 is a diagram illustrating an example of a measured stock list screen displayed by the reading device;

FIG. 10 is a diagram illustrating an example of a details screen displayed by the reading device;

FIG. 11 is a diagram illustrating an example of a state in which a serial number is selected on the details screen;

FIG. 12 is a diagram illustrating an example of a search screen displayed by the reading device;

FIG. 13 is a diagram illustrating an example of a state in which a search target is displayed on the search screen; and

FIG. 14 is a diagram illustrating an example of a state in which the serial number selected on the details screen is deleted.

### DETAILED DESCRIPTION

An object of at least one embodiment is to, in order to solve the problem described above, make it easy to find excess wireless tags with respect to theoretical stocks among measured stocks.

A stock management system in at least one embodiment includes: a theoretical-stock acquiring unit (of at least one processor) configured to acquire, from a first storing unit (storage), information concerning theoretical stocks of commodities individually managed by wireless tags; a reading processing unit (of at least one processor) configured to read information received by an antenna that transmits and receives the information to and from the wireless tags; a comparison processing unit (of at least one processor) configured to compare the information acquired by the theoretical-stock acquiring unit and the information read by the reading processing unit to associate theoretical stock numbers and measured stock numbers of the commodities; a details presenting unit (of at least one processor) configured to show, among serial numbers of commodities, the measured stock numbers which exceed the theoretical stock numbers of the measured stock numbers, at least serial numbers not included in the theoretical stocks to enable the serial number to be selected; and a search processing unit (of at least one processor) configured to search for, with the antenna, a wireless tag matching the serial number selected from the serial numbers shown by the details presenting unit.

### First Embodiment

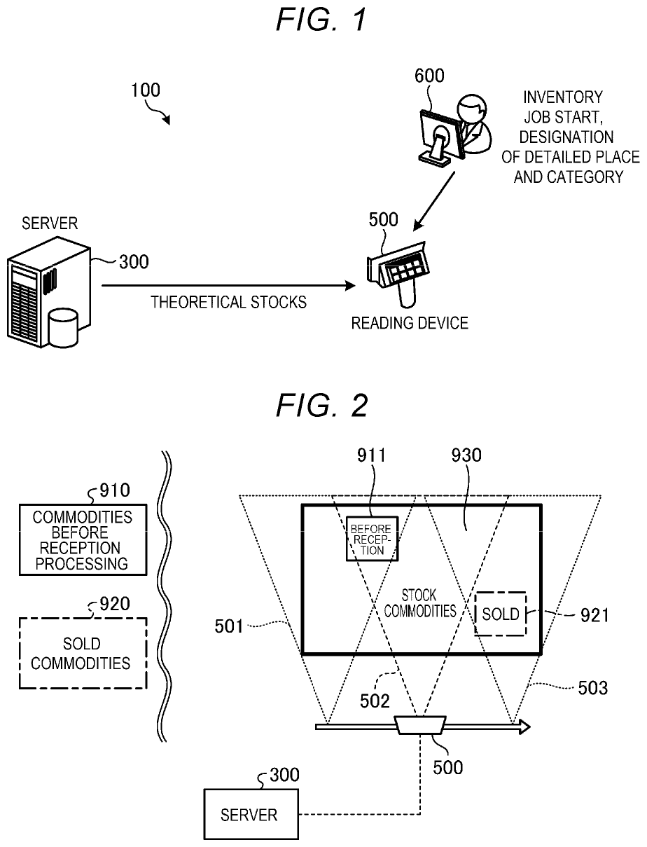

At least one embodiment is explained with reference to the drawings. FIG. 1 is a diagram schematically illustrating the configuration of a stock management system 100 in the embodiment. The stock management system. 100 includes a server 300 and a reading device 500.

The server 300 is mainly used for retaining information concerning theoretical stocks, sold commodities, commodities before reception processing, and measured stocks. The commodities before reception processing are commodities for which reception confirmation by wireless tag reading is not implemented yet. Commodities individually managed by wireless tags read in the reception processing are recorded in theoretical stocks.

The sold commodities are commodities after sales processing is performed and are commodities individually managed by wireless tags read in the sales processing. The commodities are deleted from the record of the theoretical stocks according to the sales processing.

The theoretical stocks are commodities subjected to the reception processing and before sales. That is, the theoretical stocks are the remaining commodities after the commodities individually managed by the wireless tags read by the sales processing are excluded from the commodities individually managed by the wireless tags read by the reception processing.

The measured stocks are commodities individually managed by wireless tags read by the reading device 500 in inventory. In the inventory, details of places of inventory targets, designation of categories of commodities, for example, are set in the reading device 500 beforehand via an external terminal 600 or the like.

The wireless tag is, for example, an RF tag. The RF tag is an IC tag adapted to RFID (Radio Frequency Identification, that is, a technique for exchanging information by short-range wireless communication using a radio wave). Information stored by the wireless tag is, for example, an individual article code (EPC: Electronic Product Code). The individual article code is, for example, a code obtained by adding a serial number to a JAN code.

The reading device 500 may be a portable type and transmits and receives radio waves to and from the wireless tags with an antenna to read (acquire) and write information of the wireless tags. The reading device 500 receives (acquires) information such as theoretical stocks from the server 300 and transmits information concerning measured stocks to the server 300.

FIG. 2 is a diagram schematically illustrating a state during use of the stock management system 100. In FIG. 2, an example of disposition of commodities in a back office is illustrated. In the back office, in general, commodities before reception processing 910 and sold commodities 920 are placed away from stock commodities 930. In particular, in the back office where inventory by wireless tag reading is assumed, the commodities are disposed considering a transmittable and receivable distance of the reading device 500 to prevent the commodities before reception processing 910 and the sold commodities 920 from being read by mistake when the stock commodities 930 are read.

In such aback office, if inventory by the reading device 500 is performed, an operator holding the reading device 500 to direct radio waves 501 to 503 radiated by an antenna to the stock commodities 930 moves in, for example, an arrow direction. Consequently, transmission and reception of information is performed between wireless tags attached to the stock commodities 930 and the reading device 500. The reading device 500 acquires the information from the wireless tags.

If a part of commodities before reception processing 911 and sold commodities 921 are mixed in a place for the stock commodities 930 as illustrated in FIG. 2, the reading device 500 acquires information of the wireless tags attached to the commodities 911 and 921. In this case, excess information not present in theoretical stocks is included in measured stocks. This embodiment supports treatment of the excess information and makes it easy to find the commodities 911 and 921, which are articles, to make it easy to check an actual state and make it easy to perform processing in deleting the commodities 911 and 921 without leaving the commodities 911 and 921 included in the measured stocks. In the example illustrated in FIG. 2, the commodities 911 and 921 are mixed in the place for the stock commodities 930. However, the same applies to the case in which only wireless tags are present in the place for the stock commodities 930.

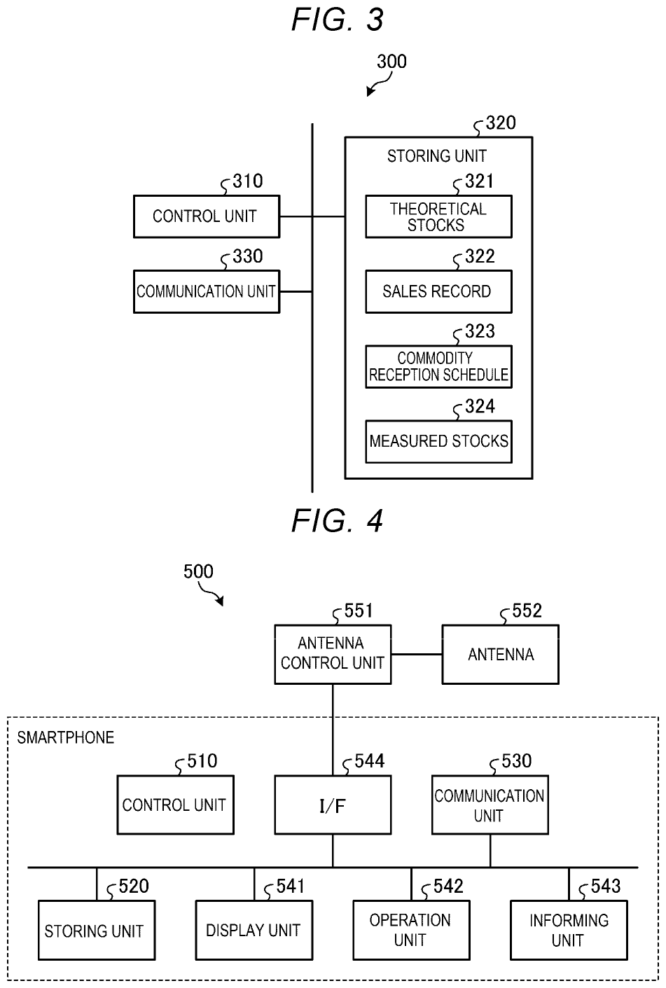

FIG. 3 is a block diagram illustrating a schematic configuration of the server 300. The server 300 includes a control unit 310, a storing unit 320, and a communication unit 330. The server 300 is configured the same as a general computer and includes a display unit (a liquid crystal display or the like) and an operation unit (a keyboard, a pointing device, or the like) as well. The communication unit 330 is an interface (I/F) for communicably connecting the server 300 to the reading device 500 by wire or radio.

The control unit 310 is configured by, for example, a CPU (Central Processing Unit), a ROM (Read Only Memory), and a RAM (Random Access Memory). The CPU is a processor and executes a program. The ROM is a program memory and stores various programs and control data. The RAM is a working memory and is used for loading of various data. The CPU is connected to the ROM, RAM, and the storing unit 320 via a data bus. The CPU reads out a program stored in the ROM to the RAM and executes the program, whereby the control unit 310 collectively controls the units.

The storing unit 320 is configured by a rewritable nonvolatile memory. The storing unit 320 can be realized by, for example, a HDD or a flash memory in which stored information is retained even if a power supply is turned off. The storing unit 320 stores a control program, control data, or the like. For example, a control program can be installed in the storing unit 320 as appropriate.

The storing unit 320 stores theoretical stock information 321, sales record information 322, commodity reception schedule information 323, measured stock information 324, for example. The theoretical stock information 321 is information concerning commodities, which are the “theoretical stocks”, and is, specifically, information (individual article codes, commodity names, sizes, colors, and the like) capable of identifying the commodities, which are the theoretical stocks. The sales record information 322 is information concerning the “sold commodities” and is, specifically, information (individual article codes, commodity names, sizes, colors, and the like) capable of identifying the sold commodities. The commodity reception schedule information 323 is information concerning the “commodities before reception processing” and is, specifically, information (individual article codes, commodity names, sizes, colors, for example) capable of identifying the commodities before reception processing. The measured stock information 324 is information concerning commodities, which are the “measured stocks”, and is, specifically, information (individual article codes, commodity names, sizes, colors, and the like) capable of identifying commodities, which are the measured stocks.

FIG. 4 is a block diagram illustrating a schematic configuration of the reading device 500. The reading device 500 includes a control unit 510 (implemented of at least one processor, for example), a storing unit 520, a communication unit 530, a display unit 541, an operation unit 542, an informing unit 543, an I/F (Interface) 544, an antenna control unit 551, and an antenna 552.

The components (the control unit 510, the storing unit 520, the communication unit 530, the display unit 541, the operation unit 542, the informing unit 543, and the I/F 544) other than the antenna control unit 551 and the antenna 552 may be configured by a portable terminal device such as a smartphone. The I/F 544 is included in the portable terminal device such as the smartphone and communicably connects the antenna control unit 551 to the control unit 510 and the like. The communication unit 530 is an interface for communicably connecting the reading device 500 to the server 300 by wire or radio.

The antenna control unit 551 controls the antenna 552 based on control by the control unit 510. The antenna 552 performs transmission and reception of radio waves according to the control by the antenna control unit 551. The display unit 541 is a display device such as a liquid crystal display and displays information for the operator on a screen. The operation unit 542 is, for example, a touch panel provided to be placed on the display unit 541 and receives operation such as an information input corresponding to display content of the display unit 541. The operation unit 542 may be an operation unit including mechanical hard keys. The informing unit 543 is, for example, a speaker and emits sound.

The control unit 510 is configured by, for example, a CPU, a ROM, and a RAM. The CPU is a processor and executes a program. The ROM is a program memory and stores various programs and control data. The RAM is a working memory and is used for loading of various data. The CPU is connected to the ROM, the RAM, and the storing unit 520 via a data bus. The CPU reads out a program stored in the ROM to the RAM and executes the program, whereby the control unit 510 collectively controls the units.

The storing unit 520 is configured by a rewritable nonvolatile memory. The storing unit 520 can be realized by, for example, a flash memory in which stored information is retained even if a power supply is turned off. The storing unit 520 stores a control program, control data, for example. For example, a control program can be installed in the storing unit 520 as appropriate.

The storing unit 520 stores information (for example, a part of the theoretical stock information 321, the sales record information 322, and the commodity reception schedule information 323) acquired from the server 300 and measured stock information (transmitted to the server 300 and stored as the measured stock information 324).

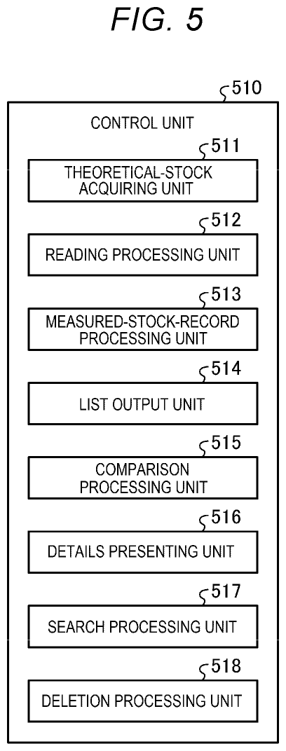

FIG. 5 is a block diagram illustrating a functional configuration of the control unit 510. The control unit 510 (implemented as at least one processor, for example) executes a program to thereby function as a theoretical-stock acquiring unit 511, a reading processing unit 512, a measured-stock-record processing unit 513, a list output unit 514, a comparison processing unit 515, a details presenting unit 516, a search processing unit 517, a deletion processing unit 518, for example.

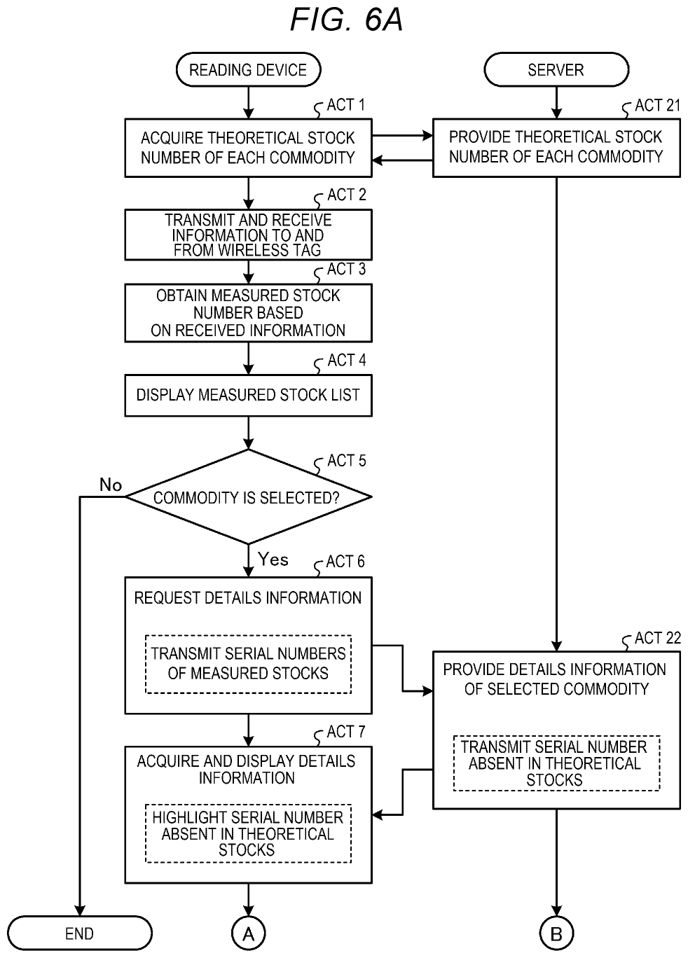

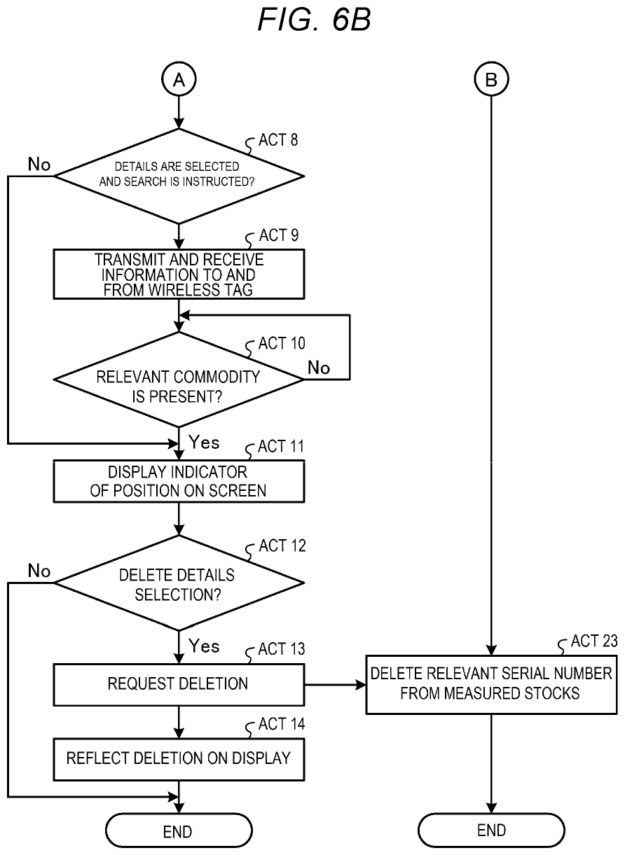

FIGS. 6A and 6B are flowcharts schematically illustrating a flow of processing performed by the control units 510 and 310 of the reading device 500 and the server 300. In the following explanation, operations of the functional units 511 to 518 are explained and processing steps corresponding to the operations are noted.

The theoretical-stock acquiring unit 511 communicates with the server 300 via the communication unit 530 to thereby acquire a theoretical stock number of each commodity provided by the server 300 (ACT 1) and causes the storing unit 520 to store the theoretical stock number. In providing the theoretical stock number of each commodity (ACT 21), the control unit 310 of the server 300 acquires information (at least an individual article code) from the theoretical stock information 321 and counts the number of individual article codes for each JAN code to thereby calculate the theoretical stock number of each commodity.

The reading processing unit 512 controls the antenna 552 via the antenna control unit 551 and transmits and receives information to and from wireless tags (ACT 2) to thereby acquire information (at least individual article codes) from the wireless tags.

The measured-stock-record processing unit 513 causes the storing unit 520 to store, as information concerning measured stocks, the information read by the reading processing unit 512. The measured-stock-record processing unit 513 counts, for each JAN code, the number of the individual article codes acquired by the reading processing unit 512 to thereby obtain a measured stock number of each commodity (ACT 3).

The list output unit 514 displays information concerning measured stocks collectively as a list for each commodity. Specifically, the list output unit 514 causes the display unit 541 to display a list table obtained by including the information concerning the measured stocks in a table-format commodity list.

In the display of the list table, the comparison processing unit 515 compares the information acquired by the theoretical-stock acquiring unit 511 and the information read by the reading processing unit 512 to associate theoretical stock numbers and measured stock numbers of commodities. Consequently, the operator can recognize, by viewing the list table, a commodity, a measured stock number of which is larger than a theoretical stock number thereof, that is, a commodity including an excess.

If a commodity is selected from the list table, the details presenting unit 516 displays a serial number of a measured stock of the commodity. In implementation, the details presenting unit 516 only has to show, among serial numbers of commodities, the measured stock numbers of which exceed the theoretical stock numbers thereof, at least serial numbers not included in the theoretical stocks to enable the serial number to be selected.

Regarding the commodities, the measured stock numbers of which exceed the theoretical stock numbers thereof, the details presenting unit 516 highlights the serial number not included in the theoretical stocks. As the highlighting, for example, the details presenting unit 516 displays the serial number not included in the theoretical stocks in red characters (or in boldfaces or with an underline) if the serial numbers of the theoretical stocks are displayed in black characters.

The search processing unit 517 searches for, with the antenna 552, a wireless tag matching the serial number selected out of the serial numbers shown by the details presenting unit 516.

The deletion processing unit 518 deletes, among the information concerning the measured stocks that the measured-stock-record processing unit 513 causes the storing unit 520 to store, information corresponding to the serial number selected out of the serial numbers shown by the details presenting unit 516.

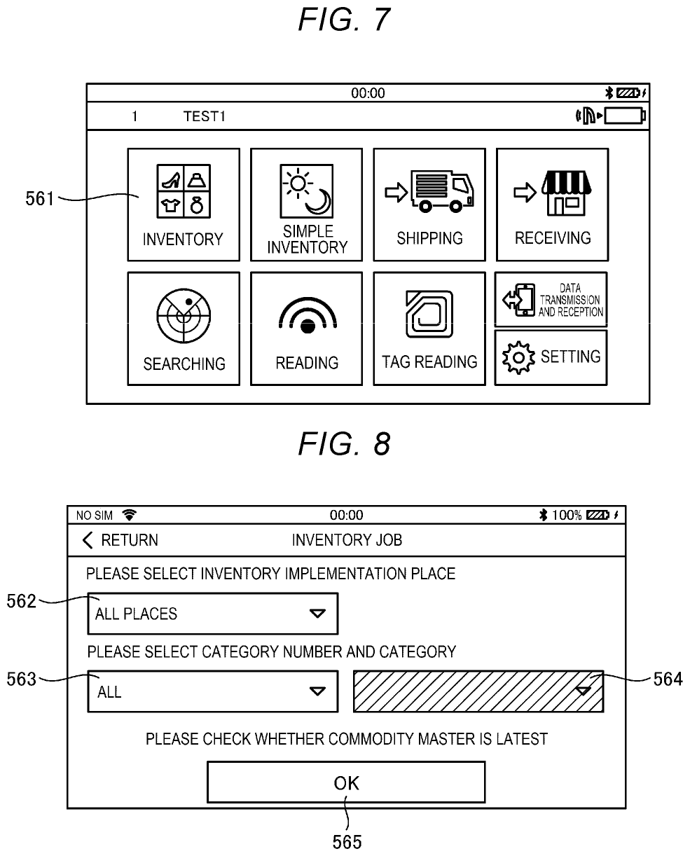

The stock management system 100 having such a configuration performs the processing illustrated in the flowchart of FIGS. 6A and 6B. In this processing, the display unit 541 of the reading device 500 displays various screens illustrated in FIG. 7 and subsequent figures. The flow of the processing is explained below with reference to the screens.

FIG. 7 is a diagram illustrating an example of a menu screen displayed by the reading device 500. The menu screen includes an inventory button 561 for starting an inventory job. If the operation unit 542 outputs a signal indicating that the inventory button 561 is operated, the control unit 510 causes the display unit 541 to display a screen illustrated in FIG. 8.

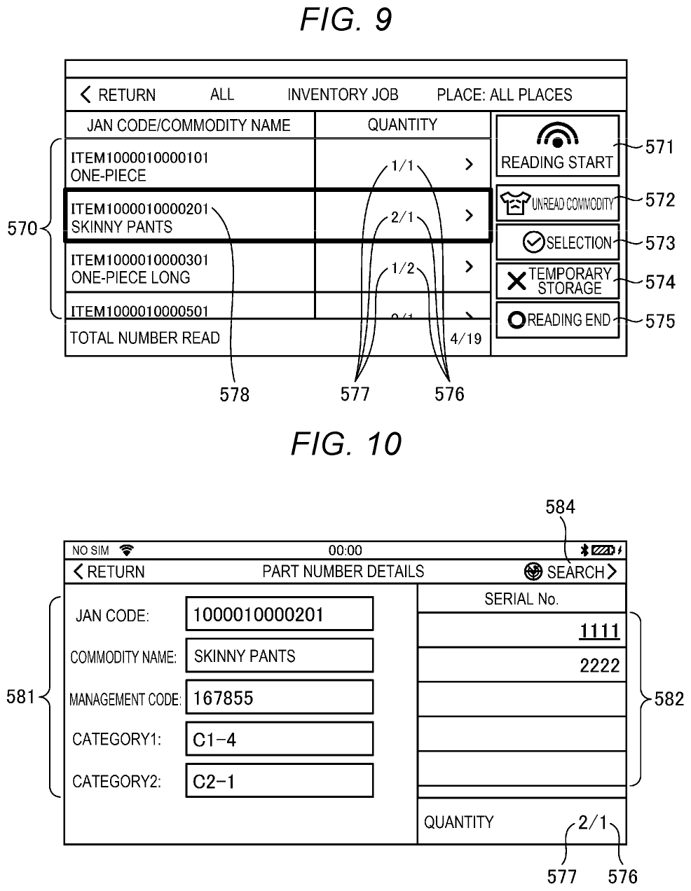

FIG. 8 is a diagram illustrating an example of an inventory target selection screen displayed by the reading device 500. On the inventory target selection screen, selection of an implementation place of inventory, a category number, and a category is received, for example, in a form of drop-down lists 562 to 564 and operation for determining the selection is received by a button 565. If the selection of the implementation place of inventory is determined, the control unit 510 causes the display unit 541 to display a screen illustrated in FIG. 9.

FIG. 9 is a diagram illustrating an example of a measured stock list screen displayed by the reading device 500. In the display of the measured stock list screen, the control unit 510 (the theoretical-stock acquiring unit 511) acquires a theoretical stock number of each commodity from the server 300 (ACT 1). At this time, the server 300 provides a theoretical stock number of each commodity as a response to a request from the reading device 500 (ACT 21).

The measured stock list screen illustrated in FIG. 9 includes a list table 570 and various buttons 571 to 575. The list table 570 compares and displays theoretical stock numbers 576 and measured stock numbers 577 for each commodity. All the measured stock numbers 577 are “0” before reading of wireless tags is started.

The button 571 is a button for declaring start and suspension of wireless tag reading by transmitting and receiving radio waves to and from the antenna 552 and is a toggle button for switching a function of receiving a start declaration and a function of receiving a suspension declaration every time operation is received. If the button 571 receives the start declaration, the control unit 510 (the reading processing unit 512) starts transmission and reception of radio waves by the antenna 552 (ACT 2). If the button 571 receives the suspension declaration, the control unit 510 stops the transmission and reception of radio waves by the antenna 552.

If reading of a wireless tag is started and radio waves are transmitted and received by the antenna 552 and information of the wireless tag is input (ACT 2), the control unit 510 (the measured-stock-record processing unit 513) obtains a measured stock number based on the received information (ACT 3). According to the measured stock number, the control unit 510 (the list output unit 514 or the comparison processing unit 515) counts up a value of the measured stock number 577 in the list table 570 (ACT 4).

A button 572 illustrated in FIG. 9 is a button for switching commodities displayed in the list table 570 to only an unread commodity, only an excess commodity, and all commodities. The three types are switched in order every time the button 572 receives operation. The unread commodity is a commodity, the measured stock number 577 of which is smaller than the theoretical stock number 576 thereof. The excess commodity is a commodity, the measured stock number 577 of which is larger than the theoretical stock number 576 thereof, and is considered to include a sold commodity and a commodity before reception processing other than theoretical stocks.

If any one of rows in the list table 570 is selected (Yes in ACT 5), the control unit 510 (the details presenting unit 516) requests the server 300 to provide details information about a commodity displayed in the selected row (ACT 6). At this time, the control unit 510 transmits serial numbers of measured stocks of the commodity in the selected row to the server 300. If a row is not selected in ACT 5 (No in ACT 5), the control unit 510 ends this processing.

The server 300 provides details information of the commodity as a response to the request (ACT 22). At this time, the server 300 transmits a serial number absent in the theoretical stocks among the serial numbers transmitted in ACT 6. At this time, if the serial number is included in a sold commodity or a commodity before reception processing, the server 300 may add information indicating to that effect.

The control unit 510 (the details presenting unit 516) causes, based on the provided details information, the display unit 541 to display a screen illustrated in FIG. 10 (ACT 7). FIG. 10 is a diagram illustrating an example of a details screen displayed by the reading device 500. On the details screen, a field 581 for displaying information concerning the commodity displayed in the row selected in the list table 570 in FIG. 9 and a field 582 for displaying a serial number of a read wireless tag.

A commodity shown in a row 578 in the list table 570 illustrated in FIG. 9 is an excess commodity. If the row 578 is selected, a serial number not included in the theoretical stocks is also displayed in the field 582 of the details screen in FIG. 10. The serial number not included in the theoretical stocks is highlighted by, for example, being displayed in red characters or boldfaces or underlined in order to make the serial number not included in the theoretical stocks more conspicuous than other serial numbers.

In the highlighting, a type of highlight may be changed to enable the serial number to be distinguished in appearance, for example, if the serial number not included in the theoretical stocks is included in, for example, a sold commodity, underline the serial number, if the serial number is included in a commodity before reception processing, display the serial number in red characters, and if the serial number is included neither in the sold commodity nor in the commodity before reception processing, display the serial number in boldfaces.

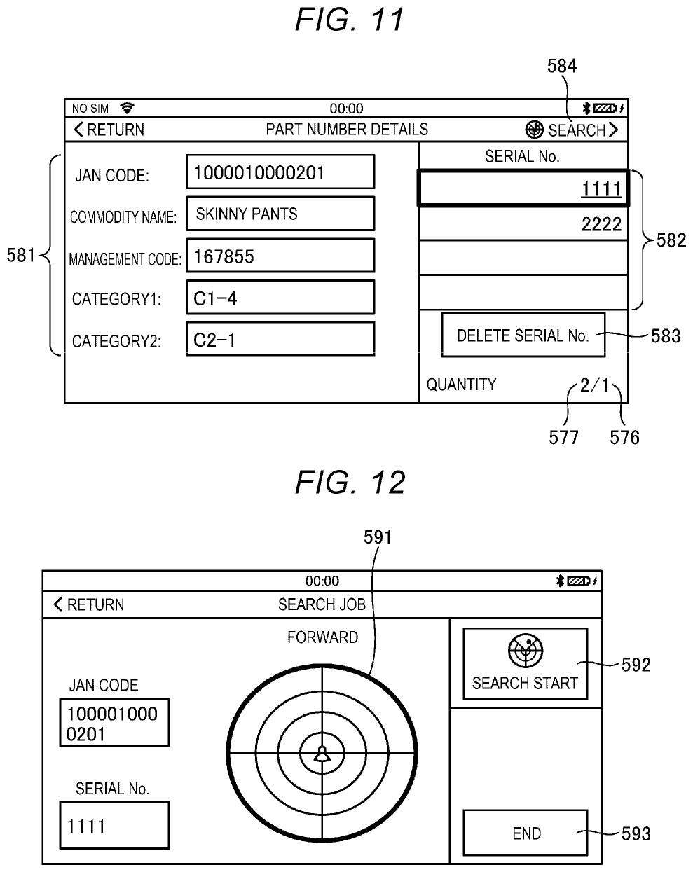

FIG. 11 is a diagram illustrating an example of a state in which the serial number is selected on the details screen. If the serial number is selected, as illustrated in FIG. 11, a button 583 appears on the details screen. The button 583 receives operation for deleting the selected serial number.

On the details screen, as illustrated in FIGS. 10 and 11, an operator 584 for instructing a search with a serial number designated is provided. If the serial number is selected on the details screen and the operator 584 is operated (Yes in ACT 8), the control unit 510 causes the display unit 541 to display a search screen illustrated in FIG. 12. FIG. 12 is a diagram illustrating an example of the search screen displayed by the reading device 500.

The search screen includes a concentric circle 591 indicating directions and distances centering on the reading device 500 and buttons 592 and 593. The button 592 receives operation for starting a search for a wireless tag with a serial number designated. The button 593 receives operation for ending a search job with the search screen displayed and returning to the details screen (FIGS. 10 and 11).

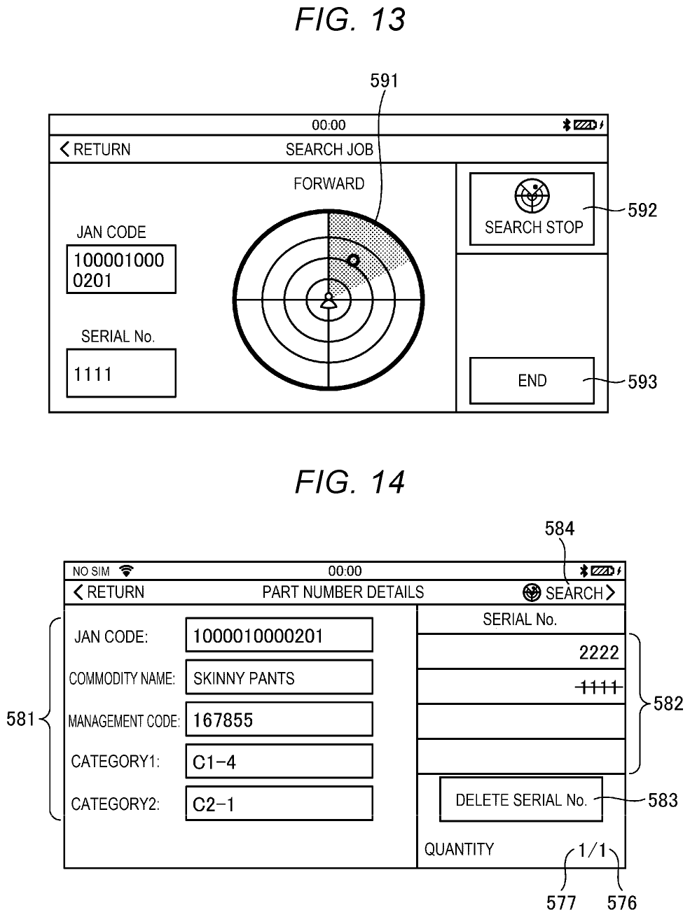

If the button 592 is operated on the details screen in FIG. 11, the control unit 510 (the search processing unit 517) controls the antenna 552 via the antenna control unit 551 and performs transmission and reception of the information with the wireless tag (ACT 9). Consequently, the control unit 510 searches for the serial number designated by the selection on the details screen (No in ACT 10). If a wireless tag corresponding to the designated serial number is found (Yes in ACT 10), as illustrated in FIG. 13, the control unit 510 causes the display unit 541 to display a point corresponding to a direction and a distance in which the wireless tag is present in the concentric circle 591 (ACT 11). FIG. 13 is a diagram illustrating an example of a state in which a search target is displayed on the search screen. The direction and the distance of the found wireless tag are estimated from directivity of the antenna 552, received radio wave intensity, and the like.

If the operator 584 is not operated in ACT 8 (No in ACT 8) and the button 583 receives operation (Yes in ACT 12), the control unit 510 (the deletion processing unit 518) transmits, to the server 300, a request for deleting the selected serial number from the measured stocks (ACT 13). If receiving the request, the server 300 deletes information concerning a measured stock corresponding to the serial number (ACT 23). Subsequently, the control unit 510 (the deletion processing unit 518) reflects the processing on display content (ACT 14), that is, applies, to the serial number in the field 582 for displaying the serial number of the wireless tag, processing for, for example, adding a strikethrough or thinning down characters. FIG. 14 is a diagram illustrating an example of a state in which the serial number selected on the details screen is deleted.

As explained above, the stock management system 100 in at least one embodiment supports the search for the wireless tag with the serial number not included in the theoretical stocks designated such that the search can be easily executed. Therefore, it is possible to make it easier to find an excess wireless tag with respect to the theoretical stocks among the measured stocks.

In the at least one embodiment explained above, the reading device 500 includes the various functional units 511 to 518. However, in implementation, anyone of the devices configuring the stock management system 100 only has to assume the functions of the functional units 511 to 518. The device assuming the functions of the functional units 511 to 518 is not limited to the reading device 500. A plurality of devices (implemented as at least one processor, for example) included in the stock management system 100 may share and realize the functions of the functional units 511 to 518.

A program executed by the stock management system 100 in this embodiment is incorporated in a ROM or the like and provided.

The program executed by the stock management system 100 in at least one embodiment may be provided while being recorded in a computer-readable recording medium such as a CD-ROM, a flexible disk (FD), a CD-R, or a DVD (Digital Versatile Disk) as a file of an installable format or an executable format.

Further, the program executed by the stock management system 100 in at least one embodiment may be stored on a computer connected to a network such as the Internet and provided by being downloaded through the network. The program executed by the stock management system 100 in this embodiment may be provided or distributed through a network such as the Internet.

The program executed by the stock management system 100 in at least one embodiment has a module configuration including the units explained above (the theoretical-stock acquiring unit 511, the reading processing unit 512, the measured-stock-record processing unit 513, the list output unit 514, the comparison processing unit 515, the details presenting unit 516, the search processing unit 517, and the deletion processing unit 518). A CPU (a processor) reads out the program from the storage medium and executes the program to thereby load the units onto a main storage device. Consequently, the theoretical-stock acquiring unit 511, the reading processing unit 512, the measured-stock-record processing unit 513, the list output unit 514, the comparison processing unit 515, the details presenting unit 516, the search processing unit 517, and the deletion processing unit 518 are generated on the main storage device.

The several embodiments are explained above. However, these embodiments are presented as examples and are not intended to limit the scope of the disclosure. These new embodiments can be implemented in other various forms. Various omissions, substitutions, and changes can be made without departing from the spirit of the invention. These embodiments and modifications of the embodiments are included in the scope and the gist of the disclosure and included in the disclosure described in claims and the scope of equivalents of the disclosure.

What is claimed is:

1. A stock management system comprising:
at least one processor configured to:
acquire, from a first storage, information concerning theoretical stocks of commodities individually managed by wireless tags;
read information received by an antenna that transmits and receives the information to and from the wireless tags;
compare the information acquired and the information read to associate theoretical stock numbers and measured stock numbers of the commodities;
show, among serial numbers of commodities, the measured stock numbers which exceed the theoretical stock numbers of the measured stock numbers, at least serial numbers not included in the theoretical stocks to enable the serial number to be selected; and
search for, with the antenna, a wireless tag matching the serial number selected from the serial numbers shown.

2. The system according to claim 1, the at least one processor further configured to cause a second storage to store the information read as information concerning measured stocks.

3. The system according to claim 2, the at least one processor further configured to delete, from the information concerning the measured stocks, information corresponding to a serial number selected out of the serial numbers shown.

4. The system according to claim 2, the at least one processor further configured to display the information concerning the measured stocks collectively as a list for each commodity.

5. The system according to claim 1, wherein the at least one processor further configured to highlight and display a serial number of a commodity, the measured stock number which exceeds the theoretical stock number thereof, not included in the theoretical stocks and being more conspicuous than the other serial numbers.

6. The system according to claim 1, wherein the at least one processor is configured as a mobile device.

7. The system according to claim 1, wherein the at least one processor is a single processor.

8. The system according to claim 1, wherein the at least one processor includes a display.

9. The system according to claim 2, wherein the at least one processor is further configured to cause a search target of the search to be displayed showing a position to the search target.

10. A stock management method comprising:
acquiring, from a first storage, information concerning theoretical stocks of commodities individually managed by wireless tags;
reading information received by an antenna that transmits and receives the information to and from the wireless tags;
comparing the information acquired and the information read to associate theoretical stock numbers and measured stock numbers of the commodities;
showing, among serial numbers of commodities, the measured stock numbers which exceed the theoretical stock numbers of the measured stock numbers, at least serial numbers not included in the theoretical stocks to enable the serial number to be selected; and
searching for, with the antenna, a wireless tag matching the serial number selected from the serial numbers shown.

11. The method according to claim 10, further comprising causing a second storage to store the information read as information concerning measured stocks.

12. The method according to claim 11, further comprising deleting, from the information concerning the measured stocks, information corresponding to a serial number selected out of the serial numbers shown.

13. The method according to claim 11, further comprising displaying the information concerning the measured stocks collectively as a list for each commodity.

14. The method according to claim 10, further comprising highlighting and displaying a serial number of a commodity, the measured stock number which exceeds the theoretical stock number thereof, not included in the theoretical stocks and being more conspicuous than the other serial numbers.
